(19) United States
(12) Patent Application Publication
(10) Pub. No.: US 2019/0113417 A1
(43) Pub. Date: Apr. 18, 2019

(54) METHOD FOR ACQUIRING THERMAL EFFICIENCY OF A BOILER

(71) Applicants: State Grid Zhejiang Electric Power Company Limited Electric Power Research Institute, Hangzhou, Zhejiang (CN); State Grid Zhejiang Electric Power Research, Hangzhou, Zhejiang (CN); STATE GRID Corporation of China, Beijing (CN); Zhejiang electric power test and Research Institut technical service center, Hangzhou, Zhejiang (CN)

(72) Inventor: Hongkun LYU, Hangzhou, Zhejiang (CN)

(21) Appl. No.: 16/090,376

(22) PCT Filed: Dec. 29, 2017
(86) PCT No.: PCT/CN2017/119634

§ 371 Date: Oct. 1, 2018

(30) Foreign Application Priority Data
Dec. 30, 2016 (CN) 201611264986.9

(51) Int. Cl. G01M 99/00; F22B 35/18; F24H 9/20; G01N 25/00; G05B 23/02

(52) U.S. Cl. CPC G01M 99/002; F22B 35/18; G05B 23/02; G01N 25/005; F24H 9/2057

(57) ABSTRACT

The present invention discloses a method for acquiring thermal efficiency of a boiler, comprising: acquiring effective output heat and total output heat of the boiler, and obtaining the thermal efficiency of the boiler according to the effective output heat and total output heat. In the method provided by the present invention, by acquiring the thermal efficiency of the boiler according to the obtained effective output heat and total output heat, the thermal efficiency of the boiler can be acquired without performing coal quality testing, thus the thermal efficiency of the boiler is conveniently obtained, and the real-time capability and accuracy are satisfied.

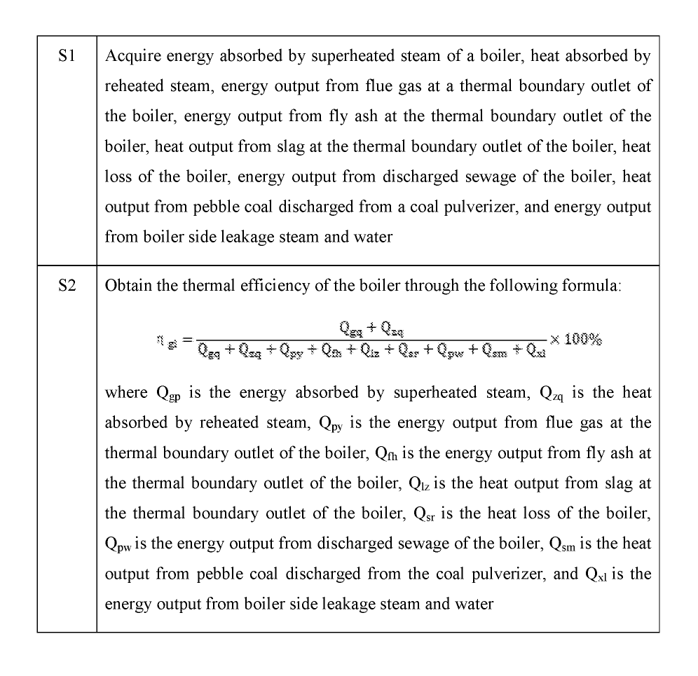

### FIELD OF THE INVENTION

The present invention relates to the technical field of boiler thermodynamic performance calculation, in particular to a method for acquiring thermal efficiency of a boiler.

### BACKGROUND OF THE INVENTION

Most of the heat that is fed into the boiler in a fuel form is absorbed by the heating surface of the boiler to produce water vapor, which is the effective heat used, while the other part is lost, which is often called as heat loss.

Generally, methods for calculating thermal efficiency of a boiler are divided into two kinds, i.e., input-output heat thermal efficiency method (also known as direct balance method) and heat loss thermal efficiency method (also known as indirect balance method).

In the actual design and calculation, whether the direct or indirect balance method is adopted for calculation, the common thing is to know the boiler's input heat, wherein the most important input heat is combustion energy input by fuel. When calculating the combustion energy, it is necessary to know the calorific value of the fuel, which usually requires sampling and analysis. It is difficult to achieve real-time capability due to complex and changeable coal quality for the boiler.

In the prior art, it is often difficult to solve the problem of quality data for the coal input to the boiler or the problem that there is no technical condition for on-line detection, so the measurement of the thermal efficiency of the boiler is usually unable to be real-time and accurate.

To sum up, how to provide a method capable of accurately acquiring thermal efficiency of a boiler in real time is a problem which needs to be urgently solved by one skilled in the art at present.

### SUMMARY OF THE INVENTION

In view of this, the purpose of the present invention is to provide a method for acquiring efficiency of a boiler, which does not involve coal quality in an acquisition process.

In order to realize the above-mentioned purpose, the present invention provides the following technical solution.

A method for acquiring thermal efficiency of a boiler comprises: acquiring effective output heat and total output heat of the boiler, and obtaining the thermal efficiency of the boiler according to the effective output heat and total output heat.

Preferably, the method for acquiring the thermal efficiency of the boiler comprises:

acquiring energy Q_{gq} absorbed by superheated steam of the boiler, heat Q_{zq} absorbed by reheated steam, energy Q_{py} output from flue gas at a thermal boundary outlet of the boiler, energy Q_{fh} output from fly ash at the thermal boundary outlet of the boiler, heat Q_{lz} output from slag at the thermal boundary outlet of the boiler, heat loss Qₛᵣ of the boiler, energy Q_{pw}, output from discharged sewage of the boiler, heat Qₛₘ output from pebble coal discharged from a coal pulverizer, and energy Qₓₗ output from boiler side leakage steam and water, and obtaining the thermal efficiency η_{gl} of the boiler through the following formula:

$${η}_{gl} = \frac{{Q}_{gq} + {Q}_{zq}}{{Q}_{gq} + {Q}_{zq} + {Q}_{py} + {Q}_{fh} + {Q}_{lz} + {Q}_{zr} + {Q}_{pw} + {Q}_{sm} + {Q}_{xl}} \times 100 \%$$

where Q_{gp} is the energy absorbed by superheated steam, Q_{zq} is the heat absorbed by reheated steam, Q_{py} is the energy output from flue gas at the thermal boundary outlet of the boiler, Q_{fh} is the energy output from fly ash at the thermal boundary outlet of the boiler, Q_{lz} is the heat output from slag at the thermal boundary outlet of the boiler, Qₛᵣ is the heat loss of the boiler, Q_{pw} is the energy output from discharged sewage of the boiler, Qₛₘ is the heat output from pebble coal discharged from the coal pulverizer, and Qₓₗ is the energy output from boiler side leakage steam and water.

Preferably, the step of acquiring the energy absorbed by the superheated steam comprises:

acquiring a flow D_{gqc} of steam at an outlet of a last-stage superheater of the boiler, an enthalpy value h_{gqc} of steam at the outlet of the last-stage superheater of the boiler, a flow D_{gjw-i} of desuperheating water at each stage injected into a water side of the boiler before a measuring point of a flow of feed water at an inlet of an economizer, a stage number n of desuperheating water injected into the water side of the boiler before the measuring point of the flow of feed water at the inlet of the economizer, an enthalpy value h_{fw} of feed water at the inlet of the economizer and an enthalpy value h_{gjw-i} of desuperheating water at each stage injected into the water side of the boiler before the measuring point of the flow of feed water at the inlet of the economizer; and calculating the heat Q_{gq} absorbed by the superheated steam according to the following formula:

$${Q}_{gq} = {D}_{gqc} {h}_{gqc} - ( {D}_{gqc} - {\sum }_{i = 1}^{n} {D}_{gjw - 1} ) {h}_{fw} - {\sum }_{i = 1}^{n} {D}_{gjw - i} {h}_{gjw - i}$$

where i is a current stage number and n is a stage number of desuperheating water injected into the water side of the boiler before the measuring point of the flow of feed water at the inlet of the economizer.

Preferably, the step of acquiring the heat Q_{zq} absorbed by reheated steam comprises:

acquiring a flow D_{zqj} of steam at an inlet of a reheater, an amount D_{zjw} of desuperheating water injected into a water side of the reheater, an enthalpy value h_{zqc} of steam at an outlet of the reheater, an enthalpy value h_{zqj} of steam at the inlet of the reheater and an enthalpy value h_{zjw} of desuperheating water of the reheater,

and calculating the heat Q_{zq} absorbed by reheated steam according to the following formula:

Q_{zq}=(D_{zqj}+D_{zjw})h_{zqc}−D_{zqj}h_{zqj}−D_{zjw}h_{zjw}

where D_{zqj} is the flow of steam at the inlet of the reheater, D_{zjw} is the amount of desuperheating water injected into the water side of the reheater, h_{zqc} is the enthalpy value of steam at the outlet of the reheater, h_{zqj} is the enthalpy value of steam at the inlet of the reheater and h_{zjw} is the enthalpy value of desuperheating water of the reheater.

Preferably, the step of acquiring the energy Q_{py} output from flue gas at the thermal boundary outlet of the boiler comprises:

calculating the energy Q_{py} output from flue gas at the thermal boundary outlet of the boiler according to the following formula:

Q_{py}=(V_{py}−1.24D_{ch})CP′_{py}(t_{py}−t₀)+126.36V_{py}Φ(CO)+D_{ch}(h_{pychs}−h_{fw})

where V_{py} is an amount of flue gas at the thermal boundary outlet of the boiler, D_{ch} is a flow of soot blowing steam, t₀ is air temperature at a thermal boundary inlet of the boiler, t_{py} is flue gas temperature at the thermal boundary outlet of the boiler, CP′_{py} is average specific heat at constant pressure of flue gas from t₀ to t_{py} after deducting the influence of soot blowing steam at the thermal boundary outlet of the boiler, Φ(CO) is volume concentration of CO gas in flue gas at the thermal boundary outlet of the boiler, h_{pychs} is water vapor enthalpy under conditions of 1.24D_{ch}/V_{py} flue gas partial pressure and t_{py} flue gas temperature, and h is the enthalpy value of feed water at the inlet of the economizer;

wherein CP′_{py} is calculated according to the following formula:

$${CP}_{py}^{′} = \frac{{Φ ( {CO}_{2} )}^{′}}{100} {CP}_{CO 2} + \frac{{Φ ( {H}_{2} O )}^{′}}{100} {CP}_{H 2 O} + \frac{{Φ ( {O}_{2} )}^{′}}{100} {CP}_{O 2} + \frac{{Φ ( CO )}^{′}}{100} {CP}_{CO} + \frac{{Φ ( {SO}_{2} )}^{′}}{100} {CP}_{SO 2} + \frac{{Φ ( {N}_{2} )}^{′}}{100} {CP}_{N 2}$$

where CP_{CO2}, CP_{H2O}, CP_{O2}, CP_{CO}, CP_{SO2} and CP_{N2} are respectively average specific heat at constant pressure of CO₂, H₂O, O₂, CO, SO₂ and N₂ from t₀ to t_{py}; Φ(Xi)′ is flue gas composition of Xᵢ after deducting the dilution of soot blowing steam to tail flue gas, X₁ is CO₂, X₂ is O₂, X₃ is CO, X₄ is SO₂ and X₅ is N₂; and Φ(H₂O)′=100−Σᵢ₌₁⁵Φ(Xᵢ)′,

wherein he flue gas composition Φ(Xi)′ of Xᵢ after deducting the dilution of soot blowing steam to tail flue gas is calculated according to the following formula:

$${Φ ( {X}_{i} )}^{′} = \frac{{V}_{py}}{{V}_{py} - 1.24 {D}_{ch}} Φ ( {X}_{i} )$$

$$Φ ( {N}_{2} ) = 100 - Φ ( {CO}_{2} ) - Φ ( {H}_{2} O ) - Φ ( {O}_{2} ) - Φ ( CO ) - Φ ( {SO}_{2} )$$

where Φ(Xᵢ) is volume concentration of gas Xᵢ in the flue gas at the thermal boundary outlet of the boiler.

Preferably, the step of acquiring the flow D_{ch} of soot blowing steam comprises:

acquiring the flow D_{ch} through a measurement device;

or acquiring the flow of feed water at the inlet of the economizer, the flow of steam at the outlet of the last-stage superheater of the boiler and the flow of desuperheating water at each stage injected into the water side of the boiler before the measuring point of the flow of feed water at the inlet of the economizer; and calculating the flow D_{ch} of soot blowing steam according to the following formula:

$${D}_{ch} = {D}_{fw} + {\sum }_{i = 1}^{n} {D}_{gjw - i} - {D}_{gqc}$$

where D_{fw} is the flow of feed water at the inlet of the economizer, D_{gqc} is the flow of steam at the outlet of the last-stage superheater of the boiler and D_{gjw-i} is the flow of desuperheating water at each stage injected into the water side of the boiler before the measuring point of the flow of feed water at the inlet of the economizer.

Preferably, the step of acquiring the energy Q_{fh} output from fly ash at the thermal boundary outlet of the boiler and the heat Q_{lz} output from slag at the thermal boundary outlet of the boiler comprises:

acquiring concentration of fly ash in flue gas at the thermal boundary outlet of the boiler, an enthalpy value of fly ash in flue gas at the thermal boundary outlet of the boiler, an enthalpy value of fly ash under a condition of raw coal temperature at an inlet of the coal pulverizer, a mass ratio of fly ash to slag at the thermal boundary outlet of the boiler, an enthalpy value of slag at the thermal boundary outlet of the boiler, an enthalpy value of slag under the condition of raw coal temperature at the inlet of the coal pulverizer, content of combustible substances in fly ash at the thermal boundary outlet of the boiler and an amount of flue gas at the thermal boundary outlet of the boiler; and calculating according to the following formula:

$${Q}_{fh} + {Q}_{lz} = μ ( ash ) {V}_{py} ( {h}_{fh} - {h}_{fh 0} ) + \frac{1}{a} μ ( ash ) {V}_{py} ( {h}_{lz} - {h}_{lz 0} ) + 0.33727 ( 1 + \frac{1}{a} ) μ ( ash ) {V}_{py} {C}_{fh}$$

where μ(ash) is the concentration of fly ash in flue gas at the thermal boundary outlet of the boiler;

h_{fh} is the enthalpy value of fly ash in flue gas at the thermal boundary outlet of the boiler;

h_{fh0} is the enthalpy value of fly ash under the condition of raw coal temperature at the inlet of the coal pulverizer;

a is the mass ratio of fly ash to slag at the thermal boundary outlet of the boiler;

h_{lz} is the enthalpy value of slag at the thermal boundary outlet of the boiler;

h_{lz0} is the enthalpy value of slag under the condition of raw coal temperature at the inlet of the coal pulverizer,

C_{fh} is the content of combustible substances in fly ash at the thermal boundary outlet of the boiler; and

V_{py} is the amount of flue gas at the thermal boundary outlet of the boiler.

Preferably, the step of acquiring the energy Q_{pw} output from discharged sewage of the boiler comprises:

acquiring an amount of discharged sewage of the boiler, an enthalpy value of discharged sewage of the boiler and the enthalpy value of feed water at the inlet of the economizer; and calculating according to the following formula: Q_{pw}=D_{pw}(h_{pw}−h_{fw}),

where D_{pw} is the amount of discharged sewage of the boiler; h_{pw} is the enthalpy value of discharged sewage of the boiler; and h_{fw} is the enthalpy value of feed water at the inlet of the economizer.

Preferably, the step of acquiring the heat Qₛₘ output from pebble coal discharged from the coal pulverizer comprises:

acquiring an amount of pebble coal discharged from the coal pulverizer, a calorific value of pebble coal, a sensible enthalpy value of discharged pebble coal and a sensible enthalpy value of pebble coal under the condition of raw coal temperature at the inlet of the coal pulverizer; and

calculating the heat Qₛₘ output from pebble coal discharged from the coal pulverizer according to the following formula:

Qₛₘ=Mₛₘ(Q_{smfr}+hₛₘ−jₛₘ₀)

where Mₛₘ is the amount of pebble coal discharged from the coal pulverizer;

Q_{smfr} is the calorific value of pebble coal;

hₛₘ is the sensible enthalpy value of discharged pebble coal; and

hₛₘ₀ is the sensible enthalpy value of pebble coal under the condition of raw coal temperature at the inlet of the coal pulverizer.

Preferably, the step of acquiring the heat loss Qₛᵣ of the boiler comprises:

acquiring a rated flow of steam at the outlet of the last-stage superheater of the boiler and the flow of steam at the outlet of the last-stage superheater of the boiler; and calculating the heat loss Qₛᵣ of the boiler according to the following formula:

$${Q}_{sr} = \frac{1}{17.18 {{D}_{gqc} ( {D}_{gqc}^{e} )}^{- 0.62} - 1} ( {Q}_{gq} + {Q}_{zq} + {Q}_{py} + {Q}_{fh} + {Q}_{lz} + {Q}_{pw} + {Q}_{sm} + {Q}_{xl} )$$

where D_{gqc}^{e} is the rated flow of steam at the outlet of the last-stage superheater of the boiler; and D_{gqc} is the flow of steam at the outlet of the last-stage superheater of the boiler.

In the acquisition method provided by the present invention, the thermal efficiency of the boiler is obtained by utilizing the acquired effective output heat and total output heat of the boiler. In the above-mentioned acquisition process, the coal quality characteristics are not involved, the thermal efficiency of the boiler can be acquired without performing coal quality testing, thus the thermal efficiency of the boiler is conveniently obtained, and the real-time capability and accuracy are satisfied.

### DESCRIPTION OF THE DRAWINGS

In order to describe more clearly the embodiments of the present invention or the technical solutions in the prior art, a brief introduction of the drawings to be used in the embodiments or the description of the prior art will be given below. Obviously, the drawings described below are merely the embodiments of the present invention, and one skilled in the art may also obtain other drawings according to the provided drawings without contributing any inventive labor.

The sole FIGURE illustrates a flowchart of a method for acquiring efficiency of a boiler provided in the present invention.

### DESCRIPTION OF THE EMBODIMENTS

A clear and complete description of the technical solution in the embodiment of the present invention will be given below in conjunction with the drawings in the embodiments of the present invention. Obviously, the embodiments described are only part of the embodiments of the present invention instead of all embodiments. Based on the embodiments of the present invention, all other embodiments obtained by one skilled in the art without contributing any inventive labor shall fall within the scope of the present invention.

The core of the present invention is to provide a method for acquiring thermal efficiency of a boiler, which does not involve coal quality acquisition in the acquisition process and is convenient and accurate.

The method for acquiring the thermal efficiency of the boiler provided by the present invention comprises:

acquiring energy Q_{gq} absorbed by superheated steam of the boiler, heat Q_{zq} absorbed by reheated steam, energy Q_{py} output from flue gas at a thermal boundary outlet of the boiler, energy Q_{fh} output from fly ash at the thermal boundary outlet of the boiler, heat Q_{lz} output from slag at the thermal boundary outlet of the boiler, heat loss Qₛᵣ of the boiler, energy Q_{pw} output from discharged sewage of the boiler, heat Qₛₘ output from pebble coal discharged from a coal pulverizer, and energy Qₓₗ output from boiler side leakage steam and water, and obtaining the thermal efficiency η_{gl} of the boiler through the following formula:

$${η}_{gl} = \frac{{Q}_{gq} + {Q}_{zq}}{{Q}_{gq} + {Q}_{zq} + {Q}_{py} + {Q}_{fh} + {Q}_{lz} + {Q}_{sr} + {Q}_{pw} + {Q}_{sm} + {Q}_{xl}} \times 100 \%$$

where Q_{gp} is the energy absorbed by superheated steam, Q_{zq} is the heat absorbed by reheated steam, Q_{py} is the energy output from flue gas at the thermal boundary outlet of the boiler, Q_{fh} is the energy output from fly ash at the thermal boundary outlet of the boiler, Q_{lz} is the heat output from slag at the thermal boundary outlet of the boiler, Qₛᵣ is the heat loss of the boiler, Q_{pw} is the energy output from discharged sewage of the boiler, Qₛₘ is the heat output from pebble coal discharged from the coal pulverizer, and Qₓₗ is the energy output from boiler side leakage steam and water.

It needs to be noted that, in order to know the thermal efficiency of the boiler in real time, the thermal efficiency is acquired according to the following formula:

$$Thermal efficnecy of boiler = \frac{Effective output heat}{Total output heat} \times 100 \%$$

$$or$$

$$Thermal efficnecy of boiler = 1 - \frac{Ineffective output heat}{Total output heat} \times 100 \%$$

where the thermal efficiency of the boiler is η_{gl} (%), wherein the effective output heat Q_{yx} (MJ/h) of the boiler and the total output heat Qₜₒₜ (MJ/h) of the boiler are specifically calculated as follows.

Specifically, please refer to the following formulas:

Q_{yx}=Q_{gq}+Q_{zq}

Qₜₒₜ=Q_{gq}+Q_{zq}+Q_{py}+Q_{fh}+Q_{lz}+Qₛᵣ+Q_{pw}+Qₛₘ+Qₓₗ

where Q_{gp} is the energy absorbed by superheated steam, unit: MJ/h;

Q_{zq} is the heat absorbed by reheated steam, unit: MJ/h;

Q_{py} is the energy output from flue gas at the thermal boundary outlet of the boiler (including sensible heat and combustion energy), unit: MJ/h;

Q_{fh} is the energy output from fly ash at the thermal boundary outlet of the boiler (including sensible heat and combustion energy), unit: MJ/h;

Q_{lz} is the heat output from slag at the thermal boundary outlet of the boiler (including sensible heat and combustion energy), unit: MJ/h;

Qₛᵣ is the heat loss of the boiler, unit: MJ/h;

Q_{pw} is the energy output from discharged sewage of the boiler, unit: MJ/j;

Qₛₘ is the heat output from pebble coal discharged from the coal pulverizer (including sensible heat and combustion energy), unit: MJ/h; and

Qₓₗ is the energy output from boiler side leakage steam and water, unit: MJ/h.

To sum up, the formula for calculating the thermal efficiency η_{gl} of the boiler can be obtained. In the acquisition method provided by the present invention, by employing the calculation formula of the boiler thermal efficiency η_{gl}, the thermal efficiency of the boiler can be acquired without performing coal quality testing, the thermal efficiency of the boiler can be conveniently obtained, and the and accuracy can be satisfied.

It needs to be noted that the unit labeled after the physical quantity in the description of the present invention is a unit applicable in the formula, but the unit is not limited to this unit. As long as the use of the formula is satisfied, the whole adjustment may be made.

On the basis of the above-mentioned embodiments, the step of acquiring the energy absorbed by the superheated steam may specifically comprise:

acquiring a flow D_{gqc} of steam at an outlet of a last-stage superheater of the boiler, an enthalpy value h_{gqc} of steam at the outlet of the last-stage superheater of the boiler, a flow D_{gjw-i} of desuperheating water at each stage injected into a water side of the boiler before a measuring point of a flow of feed water at an inlet of an economizer, a stage number n of desuperheating water injected into the water side of the boiler before the measuring point of the flow of feed water at the inlet of the economizer, an enthalpy value h_{fw} of feed water at the inlet of the economizer and an enthalpy value h_{gjw-i} of desuperheating water at each stage injected into the water side of the boiler before the measuring point of the flow of feed water at the inlet of the economizer; and calculating the heat Q_{gq} absorbed by the superheated steam according to the following formula:

$${Q}_{gq} = {D}_{gqc} {h}_{gqc} - ( {D}_{gqc} - {\sum }_{i = 1}^{n} {D}_{giw \text{-} i} ) {h}_{fw} - {\sum }_{i = 1}^{n} {D}_{giw \text{-} i} {h}_{gjw \text{-} i}$$

where i is a current stage number and n is a stage number of desuperheating water injected into the water side of the boiler before the measuring point of the flow of feed water at the inlet of the economizer.

Herein, D_{gqc} is the flow of steam at the outlet of the last-stage superheater of the boiler, unit: t/h;

h_{gqc} is the enthalpy value of steam at the outlet of the last-stage superheater of the boiler, unit: kJ/kg;

D_{gjw-i} is the flow of desuperheating water at each stage injected into the water side of the boiler before the measuring point of the flow of feed water at the inlet of the economizer, unit: t/h;

n is the stage number of desuperheating water injected into the water side of the boiler before the measuring point of the flow of feed water at the inlet of the economizer;

h_{fw} is the enthalpy value of feed water at the inlet of the economizer, unit: kJ/kg; and

h_{gjw-i} is the enthalpy value of desuperheating water at each stage injected into the water side of the boiler before the measuring point of the flow of feed water at the inlet of the economizer, unit: kJ/kg.

On the basis of any one of the above-mentioned embodiments, the step of acquiring the heat Q_{zq} absorbed by reheated steam may specifically comprise:

acquiring a flow D_{zqj} of steam at an inlet of a reheater, an amount D_{zjw} of desuperheating water injected into a water side of the reheater, an enthalpy value h_{zqc} of steam at an outlet of the reheater, an enthalpy value h_{zqj} of steam at the inlet of the reheater and an enthalpy value h_{zjw} of desuperheating water of the reheater,

and calculating the heat Q_{zq} absorbed by reheated steam according to the following formula:

Q_{zq}=(D_{zqj}+D_{zjw})h_{zqc}−D_{zqj}h_{zqj}−D_{zjw}h_{zjw}

where D_{zqj} is the flow of steam at the inlet of the reheater, unit: t/h;

D_{zjw} is the amount of desuperheating water injected into the water side of the reheater, unit: kJ/kg;

h_{zqc} is the enthalpy value of steam at the outlet of the reheater, unit: kJ/kg;

h_{zqj} is the enthalpy value of steam at the inlet of the reheater, unit: kJ/kg; and

h_{zjw} is the enthalpy value of desuperheating water of the reheater, unit: kJ/kg.

On the basis of any one of the above-mentioned embodiments, the step of acquiring the energy Q_{py} output from flue gas at the thermal boundary outlet of the boiler may specifically comprise:

calculating the energy Q_{py} output from flue gas at the thermal boundary outlet of the boiler according to the following formula:

Q_{py}=(V_{py}−1.24D_{ch})CP′_{py}(t_{py}−t₀)+126.36V_{py}Φ(CO)+D_{ch}(h_{pychs}−h_{fw})

where V_{py} is an amount of flue gas at the thermal boundary outlet of the boiler, unit: km³/h;

D_{ch} is a flow of soot blowing steam, unit: t/h;

t₀ is air temperature at a thermal boundary inlet of the boiler, unit: ° C.;

t_{py} is flue gas temperature at the thermal boundary outlet of the boiler, unit: ° C.;

CP′_{py} is average specific heat at constant pressure of flue gas from t₀ to t_{py} after deducting the influence of soot blowing steam at the thermal boundary outlet of the boiler, unit: kJ/m³ k;

Φ(CO) is volume concentration of CO gas in flue gas at the thermal boundary outlet of the boiler, unit: %;

h_{pychs} is water vapor enthalpy under conditions of 1.24D_{ch}/V_{py} flue gas partial pressure and t_{py} flue gas temperature, unit: kJ/kg; and

h_{fw} is the enthalpy value of feed water at the inlet of the economizer, unit: t/h.

Herein, CP′_{py} is calculated according to the following formula:

$${CP}_{py}^{′} = \frac{{Φ ( {CO}_{2} )}^{′}}{100} {CP}_{{CO }_{2}} + \frac{{Φ ( {H}_{2} O )}^{′}}{100} {CP}_{{H}_{2} O} + \frac{{Φ ( {O}_{2} )}^{′}}{100} {CP}_{{O}_{2}} + \frac{{Φ ( CO )}^{′}}{100} {CP}_{CO} + \frac{{Φ ( {SO}_{2} )}^{′}}{100} {CP}_{{SO}_{2}} + \frac{{Φ ( {N}_{2} )}^{′}}{100} {CP}_{{N}_{2}}$$

where CP_{CO2}, CP_{H2O}, CP_{O2}, CP_{CO}, CP_{SO2} and CP_{N2} are respectively average specific heat at constant pressure of CO₂, H₂O, O₂, CO, SO₂ and N₂ from t₀ to t_{py}, unit: kJ/m³k;

Φ(Xi)′ is flue gas composition of Xᵢ after deducting the dilution of soot blowing steam to tail flue gas, unit: %, X₁ is CO₂, X₂ is O₂, X₃ is CO, X₄ is SO₂ and X₅ is N₂; and Φ(H₂O)′=100−Σᵢ₌₁⁵Φ(Xᵢ)′,

wherein the flue gas composition Φ(Xᵢ)′ of Xᵢ after deducting the dilution of soot blowing steam to tail flue gas is calculated according to the following formula:

$${Φ ( {X}_{i} )}^{′} = \frac{{V}_{py}}{{V}_{py} - 1.24 {D}_{ch}} Φ ( {X}_{i} )$$

$$Φ ( {N}_{2} ) = 100 - Φ ( {CO}_{2} ) - Φ ( {H}_{2} O ) - Φ ( {O}_{2} ) - Φ ( CO ) - Φ ( {SO}_{2} )$$

where Φ(Xᵢ) is volume concentration of gas Xᵢ in the flue gas at the thermal boundary outlet of the boiler, unit: %.

On the basis of the above-mentioned embodiments, the step of acquiring the flow D_{ch} of soot blowing steam may specifically comprise:

acquiring the flow D_{ch} through a measurement device;

or acquiring the flow of feed water at the inlet of the economizer, the flow of steam at the outlet of the last-stage superheater of the boiler and the flow of desuperheating water at each stage injected into the water side of the boiler before the measuring point of the flow of feed water at the inlet of the economizer; and calculating the flow D_{ch} of soot blowing steam according to the following formula:

$${D}_{ch} = {D}_{fw} + {\sum }_{i = 1}^{n} {D}_{gjw \text{-} i} - {D}_{gqc}$$

where D_{fw} is the flow of feed water at the inlet of the economizer, unit: t/h; D_{gqc} is the flow of steam at the outlet of the last-stage superheater of the boiler, unit: t/h; and D_{gjw-i} is the flow of desuperheating water at each stage injected into the water side of the boiler before the measuring point of the flow of feed water at the inlet of the economizer, unit: t/h.

On the basis of any one of the above-mentioned embodiments, the step of acquiring the energy Q_{fh} output from fly ash at the thermal boundary outlet of the boiler and the heat Q_{lz} output from slag at the thermal boundary outlet of the boiler comprises:

acquiring concentration of fly ash in flue gas at the thermal boundary outlet of the boiler, an enthalpy value of fly ash in flue gas at the thermal boundary outlet of the boiler, an enthalpy value of fly ash under a condition of raw coal temperature at an inlet of the coal pulverizer, a mass ratio of fly ash to slag at the thermal boundary outlet of the boiler, an enthalpy value of slag at the thermal boundary outlet of the boiler, an enthalpy value of slag under the raw coal temperature at the inlet of the coal pulverizer, content of combustible substances in fly ash at the thermal boundary outlet of the boiler and an amount of flue gas at the thermal boundary outlet of the boiler; and calculating according to the following formula:

$${Q}_{fn} + {Q}_{lz} = µ ( ash ) {V}_{py} ( {h}_{fn} - {h}_{fh 0} ) + \frac{1}{a} µ ( ash ) {V}_{py} ( {h}_{lz} - {h}_{lz 0} ) + 0.33727 ( 1 + \frac{1}{a} ) µ ( ash ) {V}_{py} {C}_{fh}$$

where μ(ash) is the concentration of fly ash in flue gas at the thermal boundary outlet of the boiler, unit: g/Nm³;

h_{fh} is the enthalpy value of fly ash in flue gas at the thermal boundary outlet of the boiler, unit: kJ/kg;

h_{fh0} is the enthalpy value of fly ash under the condition of raw coal temperature at the inlet of the coal pulverizer, unit: kJ/kg;

a is the mass ratio of fly ash to slag at the thermal boundary outlet of the boiler;

h_{lz} is the enthalpy value of slag at the thermal boundary outlet of the boiler, unit: kJ/kg;

h_{lz0} is the enthalpy value of slag under the raw coal temperature at the inlet of the coal pulverizer, unit: kJ/kg;

C_{fh} is the content of combustible substances in fly ash at the thermal boundary outlet of the boiler, unit: %; and

V_{py} is the amount of flue gas at the thermal boundary outlet of the boiler, unit: km³/h.

On the basis of any one of the above-mentioned embodiments, the step of acquiring the energy Q_{pw} output from discharged sewage of the boiler comprises:

acquiring an amount of discharged sewage of the boiler, an enthalpy value of discharged sewage of the boiler and the enthalpy value of feed water at the inlet of the economizer; and calculating according to the following formula: Q_{pw}=D_{pw}(h_{pw}−h_{fw}),
where D_{pw} is the amount of discharged sewage of the boiler, unit: t/h; h_{pw} is the enthalpy value of discharged sewage of the boiler, unit: kJ/kg; and h_{fw} is the enthalpy value of feed water at the inlet of the economizer, unit: kJ/kg.

On the basis of any one of the above-mentioned embodiments, the step of acquiring the heat Qₛₘ output from pebble coal discharged from the coal pulverizer comprises:

acquiring an amount of pebble coal discharged from the coal pulverizer, a calorific value of pebble coal, a sensible enthalpy value of discharged pebble coal and a sensible enthalpy value of pebble coal under the condition of raw coal temperature at the inlet of the coal pulverizer; and

calculating the heat Qₛₘ output from pebble coal discharged from the coal pulverizer according to the following formula:

Qₛₘ=Mₛₘ(Q_{smfr}+hₛₘ−hₛₘ₀)

where Mₛₘ is the amount of pebble coal discharged from the coal pulverizer, unit: t/h;

Q_{smfr} is the calorific value of pebble coal, unit: kJ/kg;

hₛₘ is the sensible enthalpy value of discharged pebble coal, unit: kJ/kg; and

hₛₘ₀ is the sensible enthalpy value of pebble coal under the condition of raw coal temperature at the inlet of the coal pulverizer, unit: kJ/kg.

On the basis of any one of the above-mentioned embodiments, the step of acquiring the heat loss Qₛᵣ of the boiler comprises:

acquiring a rated flow of steam at the outlet of the last-stage superheater of the boiler and the flow of steam at the outlet of the last-stage superheater of the boiler; and calculating the heat loss Qₛᵣ of the boiler according to the following formula:

$${Q}_{sr} = \frac{1}{17.18 {{D}_{gqc} ( {D}_{gqc}^{e} )}^{- 0.62} - 1} ( {Q}_{gq} + {Q}_{zq} + {Q}_{py} + {Q}_{fh} + {Q}_{iz} + {Q}_{pw} + {Q}_{sm} + {Q}_{xl} )$$

where D_{gqc}^{e} is the rated flow of steam at the outlet of the last-stage superheater of the boiler, unit: t/h; and D_{gqc} is the flow of steam at the outlet of the last-stage superheater of the boiler, unit: t/h.

Under normal operation conditions, the leakage amount Qₓₗ and the pebble coal amount Mₛₘ of the boiler are very small, and can often be neglected. In addition, the item Q_{pw} is generally only used for drum boilers, its quantity is generally a certain proportion of evaporation, the proportion is generally very small and can be ignored, and for once-through boilers, there is no item Q_{pw}.

On the basis of any one of the above-mentioned embodiments, with respect to data acquisition, all of the above-mentioned data except the directionally acquired data related to t_{py}, V_{py}, (CO₂, H₂O, O₂, CO, and SO₂ volume concentrations), μ(ash) and C_{fh} can be acquired in real time by direct or indirect calculation through the unit DCS database, the related material parameter database and the directionally acquired data mentioned above. The exhaust gas temperature is measured in real time by a plurality of arranged thermocouples. The amount of flue gas can be measured in real time by an arranged flue gas measuring device. The flue gas composition can be measured in real time by an arranged multi-function flue gas analyzer. The concentration of fly ash can be measured in real time by an arranged fly ash concentration meter. The content of fly ash combustible can be measured in real time by an arranged fly ash combustible measuring device.

Optionally, the above-mentioned acquisition method is not unique, and the corresponding values or measurements can be acquired by adopting other monitoring and acquisition methods.

The various embodiments in the description are described in a progressive manner. Each embodiment highlights the differences from other embodiments, and for the same and similar parts of the various embodiments, a mutual reference can be made.

The method for acquiring the thermal efficiency of the boiler provided by the present invention is introduced above in detail. Specific examples are used to illustrate the principle and implementation of the present invention. The description of the above-mentioned embodiments is only intended to help understand the method and core idea of the present invention. It should be pointed out that, for one skilled in the art, without departing from the principle of the present invention, a number of improvements and modifications can be made to the present invention, which fall within the protective scope of the claims of the present invention.

1. A method for acquiring thermal efficiency of a boiler, wherein the method for acquiring the thermal efficiency of the boiler comprises: acquiring effective output heat and total output heat of the boiler, and obtaining the thermal efficiency of the boiler according to the effective output heat and total output heat.

2. The method for acquiring the thermal efficiency of the boiler according to claim 1, wherein the method for acquiring the thermal efficiency of the boiler comprises:
acquiring energy Q_{gq} absorbed by superheated steam of the boiler, heat Q_{zq} absorbed by reheated steam, energy Q_{py} output from flue gas at a thermal boundary outlet of the boiler, energy Q_{fh} output from fly ash at the thermal boundary outlet of the boiler, heat Q_{lz} output from slag at the thermal boundary outlet of the boiler, heat loss Qₛᵣ of the boiler, energy Q_{pw} output from discharged sewage of the boiler, heat Qₛₘ output from pebble coal discharged from a coal pulverizer, and energy Qₓₗ output from boiler side leakage steam and water; and
obtaining the thermal efficiency η_{gl} of the boiler through the following formula:
$${η}_{gl} = \frac{{Q}_{gq} + {Q}_{zq}}{{Q}_{gq} + {Q}_{zq} + {Q}_{py} + {Q}_{fh} + {Q}_{lz} + {Q}_{sr} + {Q}_{pw} + {Q}_{sm} + {Q}_{xl}} \times 100 \%$$
where Q_{gp} is the energy absorbed by superheated steam, Q_{zq} is the heat absorbed by reheated steam, Q_{py} is the energy output from flue gas at the thermal boundary outlet of the boiler, Q_{fh} is the energy output from fly ash at the thermal boundary outlet of the boiler, Q_{lz} is the heat output from slag at the thermal boundary outlet of the boiler, Qₛᵣ is the heat loss of the boiler, Q_{pw} is the energy output from discharged sewage of the boiler, Qₛₘ is the heat output from pebble coal discharged from the coal pulverizer, and Qₓₗ is the energy output from boiler side leakage steam and water.

3. The method for acquiring the thermal efficiency of the boiler according to claim 2, wherein the step of acquiring the energy absorbed by the superheated steam comprises:
acquiring a flow D_{gqc} of steam at an outlet of a last-stage superheater of the boiler, an enthalpy value h_{gqc} of steam at the outlet of the last-stage superheater of the boiler, a flow D_{gjw-i} of desuperheating water at each stage injected into a water side of the boiler before a measuring point of a flow of feed water at an inlet of an economizer, a stage number n of desuperheating water injected into the water side of the boiler before the measuring point of the flow of feed water at the inlet of the economizer, an enthalpy value h_{fw} of feed water at the inlet of the economizer and an enthalpy value h_{gjw-i} of desuperheating water at each stage injected into the water side of the boiler before the measuring point of the flow of feed water at the inlet of the economizer;
and calculating the heat Q_{gq} absorbed by the superheated steam according to the following formula:
$${Q}_{gq} = {D}_{gqc} {h}_{gqc} - ( {D}_{gqc} - {\sum }_{i = 1}^{n} {D}_{gjw \text{-} i} ) {h}_{fw} - {\sum }_{i = 1}^{n} {D}_{gjw \text{-} i} {h}_{gjw \text{-} i}$$
where i is a current stage number and n is a stage number of desuperheating water injected into the water side of the boiler before the measuring point of the flow of feed water at the inlet of the economizer.

4. The method for acquiring the thermal efficiency of the boiler according to claim 2, wherein the step of acquiring the heat Q_{zq} absorbed by reheated steam comprises:
acquiring a flow D_{zqj} of steam at an inlet of a reheater, an amount D_{zjw} of desuperheating water injected into a water side of the reheater, an enthalpy value h_{zqc} of steam at an outlet of the reheater, an enthalpy value h_{zqj} of steam at the inlet of the reheater and an enthalpy value h_{zjw} of desuperheating water of the reheater, and calculating the heat Q_{zq} absorbed by reheated steam according to the following formula:
Q_{zq}=(D_{zqj}+D_{zjw})h_{zqc}−D_{zqj}h_{zqj}−D_{zjw}h_{zjw}
where D_{zqj} is the flow of steam at the inlet of the reheater, D_{zjw} is the amount of desuperheating water injected into the water side of the reheater, h_{zqc} is the enthalpy value of steam at the outlet of the reheater, h_{zqj} is the enthalpy value of steam at the inlet of the reheater and h_{zjw} is the enthalpy value of desuperheating water of the reheater.

5. The method for acquiring the thermal efficiency of the boiler according to claim 3, wherein the step of acquiring the energy Q_{py} output from flue gas at the thermal boundary outlet of the boiler comprises:
calculating the energy Q_{py} output from flue gas at the thermal boundary outlet of the boiler according to the following formula:
Q_{py}=(V_{py}−1.24D_{ch})CP′_{py}(t_{py}−t₀)+126.36V_{py}Φ(CO)+D_{ch}(h_{pychs}−h_{fw})
where V_{py} is an amount of flue gas at the thermal boundary outlet of the boiler, D_{ch} is a flow of soot blowing steam, t₀ is air temperature at a thermal boundary inlet of the boiler, t_{py} is flue gas temperature at the thermal boundary outlet of the boiler, CP′_{py} is average specific heat at constant pressure of flue gas from t₀ to t_{py} after deducting the influence of soot blowing steam at the thermal boundary outlet of the boiler, Φ(CO) is volume concentration of CO gas in flue gas at the thermal boundary outlet of the boiler, h_{pychs} is water vapor enthalpy under conditions of 1.24D_{ch}/V_{py} flue gas partial pressure and t_{py} flue gas temperature, and h_{fw} is the enthalpy value of feed water at the inlet of the economizer;
wherein CP′_{py} is calculated according to the following formula:
$${CP}_{py}^{′} = \frac{{Φ ( {CO}_{2} )}^{′}}{100} {CP}_{{CO}_{2}} + \frac{{Φ ( {H}_{2} O )}^{′}}{100} {CP}_{{H}_{2} O} + \frac{{Φ ( {O}_{2} )}^{′}}{100} {CP}_{{O}_{2}} + \frac{{Φ ( CO )}^{′}}{100} {CP}_{CO} + \frac{{Φ ( {SO}_{2} )}^{′}}{100} {CP}_{{SO}_{2}} + \frac{{Φ ( {N}_{2} )}^{′}}{100} {CP}_{{N}_{2}}$$
where CP_{CO2}, CP_{H2O}, CP_{O2}, CP_{CO}, CP_{SO2} and CP_{N2} are respectively average specific heat at constant pressure of CO₂, H₂O, O₂, CO, SO₂ and N₂ from t₀ to t_{py}; Φ(Xi)′ is flue gas composition of Xᵢ after deducting the dilution of soot blowing steam to tail flue gas, X₁ is CO₂, X₂ is O₂, X₃ is CO, X₄ is SO₂ and X₅ is N₂; and Φ(H₂O)′=100−Σᵢ₌₁⁵Φ(Xᵢ)′
wherein the flue gas composition Φ(Xi)′ of Xᵢ after deducting the dilution of soot blowing steam to tail flue gas is calculated according to the following formula:
$${Φ ( {X}_{i} )}^{′} = \frac{{V}_{py}}{{V}_{py} - 1.24 {D}_{ch}} Φ ( {X}_{i} )$$
$$Φ ( {N}_{2} ) = 100 - Φ ( {CO}_{2} ) - Φ ( {H}_{2} O ) - Φ ( {O}_{2} ) - Φ ( CO ) - Φ ( {SO}_{2} )$$
where Φ(Xᵢ) is volume concentration of gas Xᵢ in the flue gas at the thermal boundary outlet of the boiler.

6. The method for acquiring the thermal efficiency of the boiler according to claim 5, wherein the step of acquiring the flow D_{ch} of soot blowing steam comprises:
acquiring the flow D_{ch} through a measurement device;
or acquiring the flow of feed water at the inlet of the economizer, the flow of steam at the outlet of the last-stage superheater of the boiler and the flow of desuperheating water at each stage injected into the water side of the boiler before the measuring point of the flow of feed water at the inlet of the economizer; and calculating the flow D_{ch} of soot blowing steam according to the following formula:
$${D}_{ch} = {D}_{fw} + {\sum }_{i = 1}^{n} {D}_{gjw \text{-} i} - {D}_{gqc}$$
where D_{fw} is the flow of feed water at the inlet of the economizer, D_{gqc} is the flow of steam at the outlet of the last-stage superheater of the boiler and D_{gjw-i} is the flow of desuperheating water at each stage injected into the water side of the boiler before the measuring point of the flow of feed water at the inlet of the economizer.

7. The method for acquiring the thermal efficiency of the boiler according to claim 2, wherein the step of acquiring the energy Q_{fh} output from fly ash at the thermal boundary outlet of the boiler and the heat Q_{lz} output from slag at the thermal boundary outlet of the boiler comprises:
acquiring concentration of fly ash in flue gas at the thermal boundary outlet of the boiler, an enthalpy value of fly ash in flue gas at the thermal boundary outlet of the boiler, an enthalpy value of fly ash under a condition of raw coal temperature at an inlet of the coal pulverizer, a mass ratio of fly ash to slag at the thermal boundary outlet of the boiler, an enthalpy value of slag at the thermal boundary outlet of the boiler, an enthalpy value of slag under the raw coal temperature at the inlet of the coal pulverizer, content of combustible substances in fly ash at the thermal boundary outlet of the boiler and an amount of flue gas at the thermal boundary outlet of the boiler; and calculating according to the following formula:
$${Q}_{fn} + {Q}_{lz} = µ ( ash ) {V}_{py} ( {h}_{fn} - {h}_{fh 0} ) + \frac{1}{a} µ ( ash ) {V}_{py} ( {h}_{lz} - {h}_{lz 0} ) + 0.33727 ( 1 + \frac{1}{a} ) µ ( ash ) {V}_{py} {C}_{fh}$$
where μ(ash) is the concentration of fly ash in flue gas at the thermal boundary outlet of the boiler;
h_{fh} is the enthalpy value of fly ash in flue gas at the thermal boundary outlet of the boiler;
h_{fh0} is the enthalpy value of fly ash under the condition of raw coal temperature at the inlet of the coal pulverizer;
a is the mass ratio of fly ash to slag at the thermal boundary outlet of the boiler;
h_{lz} is the enthalpy value of slag at the thermal boundary outlet of the boiler;
h_{lz0} is the enthalpy value of slag under the raw coal temperature at the inlet of the coal pulverizer;
C_{fh} is the content of combustible substances in fly ash at the thermal boundary outlet of the boiler; and
V_{py} is the amount of flue gas at the thermal boundary outlet of the boiler.

8. The method for acquiring the thermal efficiency of the boiler according to claim 2, wherein the step of acquiring the energy Q_{pw} output from discharged sewage of the boiler comprises:
acquiring an amount of discharged sewage of the boiler, an enthalpy value of discharged sewage of the boiler and the enthalpy value of feed water at the inlet of the economizer; and calculating according to the following formula: Q_{pw}=D_{pw}(h_{pw}−h_{fw}),
where D_{pw} is the amount of discharged sewage of the boiler; h_{pw} is the enthalpy value of discharged sewage of the boiler; and h_{fw} is the enthalpy value of feed water at the inlet of the economizer.

9. The method for acquiring the thermal efficiency of the boiler according to claim 2, wherein the step of acquiring the heat Qₛₘ output from pebble coal discharged from the coal pulverizer comprises:
acquiring an amount of pebble coal discharged from the coal pulverizer, a calorific value of pebble coal, a sensible enthalpy value of discharged pebble coal and a sensible enthalpy value of pebble coal under the condition of raw coal temperature at the inlet of the coal pulverizer; and
calculating the heat Qₛₘ output from pebble coal discharged from the coal pulverizer according to the following formula:
Qₛₘ=Mₛₘ(Q_{smfr}+hₛₘ−hₛₘ₀)
where Mₛₘ is the amount of pebble coal discharged from the coal pulverizer;
Q_{smfr} is the calorific value of pebble coal;
hₛₘ is the sensible enthalpy value of discharged pebble coal; and
hₛₘ₀ is the sensible enthalpy value of pebble coal under the condition of raw coal temperature at the inlet of the coal pulverizer.

10. The method for acquiring the thermal efficiency of the boiler according to claim 2, wherein the step of acquiring the heat loss Qₛᵣ of the boiler comprises:
acquiring a rated flow of steam at the outlet of the last-stage superheater of the boiler and the flow of steam at the outlet of the last-stage superheater of the boiler; and calculating the heat loss Qₛᵣ of the boiler according to the following formula:
$${Q}_{sr} = \frac{1}{17.18 {{D}_{gqc} ( {D}_{gqc}^{e} )}^{- 0.62} - 1} ( {Q}_{gq} + {Q}_{zq} + {Q}_{py} + {Q}_{fh} + {Q}_{lz} + {Q}_{pw} + {Q}_{sm} + {Q}_{xl} )$$
where D_{gqc}^{e} is the rated flow of steam at the outlet of the last-stage superheater of the boiler; and D_{gqc} is the flow of steam at the outlet of the last-stage superheater of the boiler.
